(19) United States
(12) Patent Application Publication
(10) Pub. No.: US 2005/0210054 A1
(43) Pub. Date: Sep. 22, 2005

(54) Information management system

(76) Inventor: Michael Harris, Evanston, IL (US)

Correspondence Address: SWIDLER BERLIN LLP, 3000 K STREET, NW, BOX IP, WASHINGTON, DC, 20007, US

(21) Appl. No.: 10/982,868

(22) Filed: Nov. 8, 2004

Related U.S. Application Data
(63) Continuation-in-part of application No. 10/805,273, filed on Mar. 22, 2004.

(51) Int. Cl. G06F 7/00

(52) U.S. Cl. 707/101

(57) ABSTRACT

A method for analyzing a given set of data and then compressing the data based on the analysis is disclosed. The method includes a system for compressing and managing data using, for example, a computer based user interface. Also included are a plurality of compression algorithms that may be used to determine the optimal compression ratio for a given set of data. The algorithm that produces the optimal compression ratio may then be used to iteratively compress the given set of data. Preferably, each set of data may be managed, compressed, and decompressed based on the computer based user interface. This may allow a user to optimally compress, and then decompress, selected sets of data as desired. The user interface, preferably a graphical user interface, may be capable of managing the compressed and uncompressed data. Preferably, the user interface allows data to be visually displayed and manipulated. The manipulation may include, for example, manually or automatically archiving, editing, compressing, and decompressing.

### CROSS-REFERENCE TO RELATED APPLICATIONS

The present invention is a Continuation-in-Part of U.S. patent application No. Ser. No. 10/805,273, filed Mar. 22, 2004, entitled “Information Management System.”

### FIELD OF THE INVENTION

The present invention relates to a method for compressing, file retrieval, and managing data based on a computer based interface. More specifically, the present invention relates to a method of compressing and managing data over an information technology network using a plurality of compression algorithms to determine an optimal compression ratio.

### BACKGROUND OF THE INVENTION

Memory storage devices, such as Read-Only Memory (ROM) have been used in many different types of electronic devices. These devices range from video games, to computers, to hand held Personal Digital Assistants (PDA's). Despite the wide variety of applications in which memory storage devices are employed, each application shares one similar goal. That is, the desire to maximize the amount of data that can be stored in a memory. Two prominent reasons for this common approach are that memory is expensive, and consumes a large amount of space. Over the years, integrated circuit technology has advanced, allowing a greater amount of data to be stored in increasingly smaller amounts of space. However, with advances in memory storage capability have come advances in other areas of technology. Electronic devices now store computer programs that consume large amounts of memory. Additionally, modern technologies such as handheld music players require large amounts of memory to store songs and other data. Thus, despite the advances in circuit technology, the desire to store large amounts of data in a small amount of space has continued to increase.

In addition to advancing integrated circuit technology, many manufacturers sought to maximize the amount of data that can be stored in a memory by compressing data for storage. With the invention of networks, such as the Internet, data compression techniques acquired a new importance. In order to transmit information between two or more points, large files often take long amounts of time to be completely transmitted. Thus, compressing files allows transmission times to be reduced. Many different data compression techniques have been used to maximize the amount of available storage space in a memory. Some methods involve hardware, such as analog to digital converters, filters, and coders and decoders. Other more sophisticated technologies use mathematical algorithms in order to compress data.

Typically data compression tools are limited to a single algorithm that removes bit level redundancies before data is stored or transmitted. Alternately, some of these methods use a single algorithm to perform more than one compression using the same algorithm.

Other compression technologies have employed mathematical algorithms to perform compression on a “block,” or predetermined portion of data. These methods have the advantage of compressing data quickly. However, they often sacrifice optimal compression for speed. Other methods have been specifically tailored for a particular type of data, such as audio, video, or text. Some compression methods have employed more than one algorithm to compress a set of data. However, these methods typically involve rigidly using the one or more algorithms in a set sequence to compress data. Each of these methods, however, lacks the ability to analyze the data before determining which algorithms provide optimal compression.

In addition to the disadvantages of existing compression methods described above, typical compression methods do not provide an information management tool for managing compressed files. For example, typical compression methods do not provide a way to select and decompress a single file that is compressed within a group of files. In addition, typical compression methods do not provide a method for automatically or manually managing and archiving files according to predetermined criteria. Thus, there is a large area for improvement over existing compression techniques.

The Total Cost of Ownership in managing data consists of two major functional areas 1) the hardware required to support data storage and archiving requirements, and 2) the management of this data. A continuing need exists for data compression methods capable of analyzing and compressing data, while providing efficient and effective information tools to optimize performance over an information technology network.

### SUMMARY OF THE INVENTION

The present invention substantially reduces the disadvantages of prior art compression methods by providing a method for analyzing a given set of data and then compressing the data based on the analysis. The present invention includes a system for compressing and managing data using, for example, a computer based user interface. Also included are a plurality of compression algorithms that may be used to determine the optimal compression ratio for a given set of data. The algorithm that produces the optimal compression ratio may then be used to iteratively compress the given set of data. Preferably, each set of data may be managed, compressed, and decompressed based on the computer based user interface. This may allow a user to optimally compress, and then decompress, selected sets of data as desired from and to any network resource.

In one embodiment, the present invention comprises a data compression method. The method preferably includes analyzing data based on a plurality of algorithms to determine a compression ratio for each algorithm. The data may then be compressed based on the algorithm that produces the best compression ratio. It may be desirable for the compressed data to include at least one index file that references the algorithm that produces the best compression ratio. In one embodiment, the compressed data may be decompressed based on a last index file that is attached to the data.

In one embodiment, the algorithms preferably compress data by removing and indexing repeating bit patterns. As a by-product, the data has repeating bit patterns removed and indexed no longer has a predictable format. Thus, the compression method according to the present invention is capable of generating an encrypted data stream output. In one embodiment, the data compression may be initiated based on a command from a user interface. It may occasionally be desirable to decompress a portion of the compressed data without decompressing the remaining portion of the data. This may be achieved based on a command issued by the user interface. In other embodiments, it may be desirable to introduce additional data. In such embodiments, the additional data may be compressed and associated with the compressed data automatically. To allow a user to easily identify compressed data using the user interface, a descriptive tag may be associated with the compressed data.

In another embodiment, the present invention comprises a method for compressing data for transmission. The method includes analyzing data based on a plurality of algorithms to determine a compression ratio for each algorithm. The data is then compressed a first time based on the algorithm that produces the best compression ratio. Preferably, the compressed data may be analyzed based on the plurality of algorithms to determine a compression ratio for each algorithm. Then, the data may be compressed iteratively based on the algorithm that produces the best compression ratio.

In this embodiment, the algorithms preferably remove repeating bit patterns in order to perform the compression. It may be desirable for a first index file to be attached to the data at substantially the same time as the data is compressed a first time. The index file is be updated for each successive iteration. It is desirable for the index file to reference the algorithm that produces data with the least number of bits. When it is desirable to decompress the compressed data, the decompression may be performed based on the last index file that is attached to the data. In other embodiments, a portion of the compressed data may be decompressed based on a command from a user interface. In some applications, it may be desirable to select additional data to be compressed and associated with the already compressed data. Preferably, this is performed automatically. In order to aid a user in determining the contents of compressed data, a descriptive tag may be compressed and associated with the compressed data based on a command from the user interface.

In another embodiment, the present invention comprises a method for transferring a digital identification mark with compressed data over a data transmission medium. The method includes compressing data based on a plurality of algorithms to determine a data compression ratio associated with each algorithm. Then, the data is iteratively compressed based upon using the algorithm that produces the best data compression ratio. Preferably, a compressed digital identification mark having a unique authentication code may then be generated. The digital identification mark may then be compressed with the second set of compressed data to produce a single mass of compressed data. Preferably, the single mass of compressed data may be transmitted over a data transmission medium.

According to another aspect, the present invention includes a method for searching one or more archived files. The method comprises generating a keyword index based on one or more keywords included in a file, storing the keyword index at a first point on a data network, and storing the file at a second point on the data network. The stored file is preferably stored in a compressed format. In one embodiment, the method further comprises searching the keyword index and selecting at least one keyword. The keywords may comprise one of predetermined keywords and at least some of a plurality of words that may be included in the file. The keyword preferably includes a pointer that stores the location of the file on the data network. The file may then be transferred from the second point to the first point. The one or more keywords may be capable of determining the location of the second point. The compressed file is preferably capable of being searched based on the keyword index. It may be desirable for the method to further comprise decompressing the file.

According to one aspect of the present invention, the file comprises one of a document, email, MS-Office Suite output file, graphics, audio, and video. Storing the file in a compressed format may comprise analyzing the file based on a plurality of algorithms to determine a compression ratio for each algorithm, and compressing the file based on the algorithm that produces the best compression ratio. Preferably, storing the file at the second point occurs during more than one time period.

In one embodiment, storing the file at the second point on the data network is based on one or more rules. The one or more rules may comprise at least one of file size, time of last access, last update, and file type. Preferably, the rules are executed when network usage is below a predetermined threshold. It may be desirable for the present invention to further comprise monitoring the rate of processor usage based on storing the file at the second point on the data network and controlling the amount of processing time used based on the monitoring. Preferably, the keyword index is capable of being viewed based on a user interface.

According to another aspect, the present invention comprises a method of searching a plurality of stored files. The method preferably comprises generating a plurality of keywords based on a plurality of files, generating a keyword index based on the plurality of keywords, storing the plurality of files based on a compressed format, searching for at least one file based on the keyword index, and retrieving the at least one file based on the keyword index. The plurality of keywords are preferably capable of determining the location of the at least one file.

According to this aspect, the plurality of files are stored in a first location on a data network and the keyword index is stored at a second location on the data network. Preferably, the plurality of keywords include a plurality of pointers that are capable of storing the location of the plurality of files. Accordingly, the plurality of files based on the compressed format are capable of being searched based on the keyword index.

In one embodiment, the plurality of files are stored at the first location based on one or more rules. The one or more rules may include at least one of file size, time of last access, last update, and file type. Preferably, the rules are executed when network usage is below a predetermined threshold. Storing the plurality of files may occur during more than one time period. In one embodiment, the method may further comprise monitoring the rate of processor usage based on the storing of the plurality of files and controlling the amount of processing time used based on the monitoring.

According to another aspect, the present invention includes a method of searching a plurality of stored files. The method comprises generating a keyword index based on a plurality of files, storing the plurality of files based on a compressed format, searching for at least one compressed file based on the keyword index, retrieving the at least one file based on the keyword index, and decompressing the at least one file. In such an embodiment, the keyword index and the plurality of compressed files are stored in substantially separate locations. The keyword index preferably comprises a plurality of pointers capable of storing information about the location of each of the plurality of files. In one embodiment, the keyword index may be stored in a central database. The plurality of files may be stored in a remote database.

According to one embodiment, the file may be decompressed based on at least one of a laptop computer, a desktop computer, a Personal Digital Assistant (PDA), a cellular telephone, a database, and a server. Decompressing the plurality of compressed files may be based on an index file that is attached to the file.

### BRIEF DESCRIPTION OF THE DRAWINGS

Further features and advantages of the invention can be ascertained from the following detailed description that is provided in connection with the drawing(s) described below:

FIG. 1 is a block diagram showing an overview of one embodiment of the present invention;

FIG. 2 is a diagram showing one embodiment of a graphical user interface;

FIG. 3 is a block diagram showing an overview of exemplary steps in the decompression process;

FIG. 4 is a block diagram showing an overview of exemplary steps in the editing process; and

FIG. 5 is a block diagram showing an overview of one embodiment of the transfer of software between a server and a user's computer.

### DETAILED DESCRIPTION OF THE PREFERRED EMBODIMENTS

Data compression methods have a wide variety of applications. Traditionally, these methods were employed to maximize the use of storage space in a memory. Data compression was necessary because of the high cost of memory, such as Read-Only Memory (ROM). Many data compression methods employ mathematical algorithms that allow compressed data to occupy a smaller amount of space than the original, uncompressed data. With the invention of the Internet, data compression has found new importance. Data compression techniques are now used to compress data before it is transmitted from one point to another. Compressing data before it is transmitted has many advantages, including allowing data to be transmitted between two or more points as quickly as possible.

The data compression methods that are currently available have several limitations. One limitation is that many methods employ only one algorithm to compress a given set of data. Other methods use more than one algorithm, although these methods often compress data by using the algorithms in a set sequence. In addition to the number and sequence of algorithms that are used, many compression techniques perform compression on a “block” of data, or at the bit level. Each of these methods, however, has the disadvantage of being unable to adapt to a given set of data. One disadvantage of not being able to adapt to a given set of data is that data may not always be compressed in the most efficient manner.

The present invention substantially reduces the disadvantages of prior art compression methods by providing a method for analyzing a given set of data and then compressing the data based on the analysis. The present invention includes a system for compressing and managing data using, for example, a computer based user interface. Also included are a plurality of compression algorithms that may be used to determine the optimal compression ratio for a given set of data. The algorithm that produces the optimal compression ratio may then be used to iteratively compress the given set of data. Preferably, each set of data may be managed, compressed, and decompressed based on the computer based user interface. This may allow a user to optimally compress, and then decompress, selected sets of data as desired.

Compression and Decompression

As mentioned above, the present invention may be capable of using a plurality of algorithms to compress a given set of data. In one embodiment, it may be desirable for the algorithms to compress the given set of data at the bit level. One advantage of using an algorithm that compresses data at the bit level is that optimal compression may be achieved. Another advantage of bit level compression is that the algorithms may compress any type of data, for example, audio, video, text, and the like. Thus, the present invention may be capable of performing compression without regard to the type of data being used, which allows greater flexibility. In a preferred embodiment, the present invention is not intended to be limited to any type of algorithm. For example, in one embodiment, the plurality of algorithms may perform bit level compression using any desired method. The algorithms may perform compression based on, for example, removing repeating bit patterns. In this embodiment, a given algorithm preferably removes and indexes repeating bit patterns in order to remove any redundancy. Preferably, algorithms that remove and index repeating bit patterns are lossless. In other words, substantially no information is lost during the removal and indexing of the repeating bit patterns. In another embodiment, a well known compression algorithm may be used. Additionally, a combination of algorithms that perform compression based on different methods may be used.

In one embodiment, the present invention may be used with any number of algorithms. Preferably, the number of algorithms may be about 500 or less. More preferably, the number of algorithms that may be used is about 50 or less, and most preferably the number of algorithms that may be used is about 20 or less.

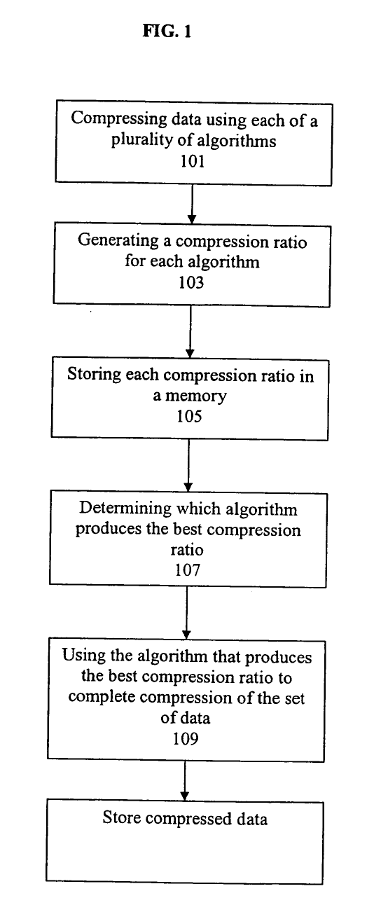

FIG. 1 is a block diagram showing an overview of one embodiment of the present invention. In one embodiment, the present invention may be capable of analyzing a given set of data, which may have any desired size. Preferably, a processor may be used to analyze the set of data based on the plurality of algorithms. In this embodiment, the analysis comprises compressing the set of data using each of the plurality of algorithms 101. After compressing the data using each of the plurality of algorithms, a compression ratio may be generated for each algorithm 103. The compression ratio may preferably be stored in a memory that is operatively connected to the processor, as shown in step 105. In one embodiment, the compression ratio may be the ratio of the size of the compressed file to the original size of the file. In other embodiments, the compression ratio may be the ratio of the size of the uncompressed file to the size of the compressed file. Regardless of the method used to calculate the ratio, it is desirable that the ratio is calculated in a substantially similar manner for each algorithm. This provides the advantage of allowing the processor to compare the various compression ratio's in order to determine which algorithm provides the most optimal compression relative to the other algorithms. Another advantage of compression based on determining a compression ratio is that any type of algorithm may be used, as described above. It may be desirable to use algorithms that perform compression based on different methods in order to determine the best compression ratio for a given set of data.

In one embodiment, uncompressed data may be compressed up to an optimal amount in order to determine a compression ratio for each of the plurality of algorithms. Preferably, the data may be compressed by between about 10% and 90% of its original size. More preferably, the data may be compressed by between about 25% and 90%s, and most preferably the data may be compressed by between about 35% and 90% of its original size. One advantage of compressing the data up to a desired percentage of its original size is that an accurate compression ratio may be generated without using the processor resources that are needed to completely compress the data. This may result in both time and cost savings.

After each of the plurality of algorithms have been used to determine a compression ratio, the processor compares the compression ratio's to determine which algorithm produces the best compression ratio, shown in step 107. In one embodiment, the algorithm that produces the best compression ratio may be used to complete the compression of the set of data, as shown in step 109. Though the compression has been described for a single set of data, it will be understood that the compression may be repeated for a plurality of sets of data.

In some embodiments, it may be desirable to perform compression iteratively. In other words, it may be desirable to perform compression on the data that has already been compressed. Data that is compressed a first time may be capable of further compression. Iterative compression allows the data to be compressed a plurality of times until the data may no longer be compressed, or alternately, until it is no longer desirable to compress the data. In some embodiments, it may be desirable to limit the number of times data is compressed to preserve processing power, to save time, to reduce cost, and the like.

In an embodiment where iterative compression may be desirable, the compression may be performed by the processor for each of the plurality of algorithms in order to determine a compression ratio, as described above. After each of the plurality of algorithms have been used to determine a compression ratio, the processor compares the compression ratio's to determine which algorithm produces the best compression ratio. In one embodiment, the algorithm that produces the best compression ratio may be used to complete the compression of the set of data. In one embodiment, after the set of data is compressed a first time, steps 101-109 may be repeated. Preferably, the processor compresses the compressed data to between about 50% to 90% of its original size.

In one embodiment, the compression may be performed using each of the plurality of algorithms in order to determine a second compression ratio. Once the compression ratios are determined, they may be compared by the processor to determine which algorithm produces the best compression ratio for the data that is compressed a first time. Preferably, the algorithm that produces the best compression ratio may be used to compress the data a second time. In this embodiment, the algorithm selected for the second compression may be the same, or different than the algorithm selected for the first compression.

In another embodiment, iterative compression may be performed using the same algorithm for each iteration. In such an embodiment, the uncompressed data may be compressed up to a predetermined amount. The compression may be performed by the processor for each of the plurality of algorithms in order to determine a compression ratio, as described above. After each of the plurality of algorithms have been used to determine a compression ratio, the processor compares the compression ratio's to determine which algorithm produces the best compression ratio. In one embodiment, the algorithm that produces the best compression ratio may be used to complete the compression of the set of data. In this embodiment, the same algorithm may be used to compress the data a second time. The compression using the same algorithm may be performed a plurality of times until further compression is undesirable or impossible. Alternately, the same algorithm may be used for the second compression, and a different algorithm may be used for successive compressions. In this embodiment, after the same algorithm is used to perform two compressions, a compression ratio is determined for each of the plurality of algorithms, as described above. The compression ratios are then compared to determine which algorithm produces the best compression ratio. The algorithm that produces the best compression ratio may then be used to perform the third compression. In some embodiments, this process may be repeated a plurality of times until further compression is not possible or undesirable.

In embodiments where iterative compression is performed, it may be desirable to limit the scale of compression by either the number of data compression algorithms used or times the data is compressed. As described above, this may be desirable to limit the time required for compression, reduce cost, and the like. In one embodiment, the processor may determine how many times a set of data should be compressed based on the compression ratios for each algorithm. This processor may make this determination in any desirable manner. In one embodiment, the compression may be repeated until substantially no additional repeating binary patterns may be removed. In another embodiment the processor may determine how many iterations of compression to perform based on the change in the compression ratios. For instance, in one embodiment described above, each of the plurality of algorithms is used to determine a compression ratio for the data that has been compressed a first time. In this embodiment, the processor may compare the best compression ratio to the best compression ratio that was determined for the uncompressed data. In one embodiment, if the percentage change in the compression ratios is substantially small, the processor may determine that no further compression is desirable. Preferably, compression may no longer be performed when the percentage change in the compression ratio is less than 5%. More preferably, compression may no longer be performed when the percentage change in the compression ratio is less than 2%, and most preferably compression may no longer be performed when the percentage change in the compression ratio is less than 0.5%. In another embodiment, compression may be performed a predetermined number of times. In such an embodiment it may be preferable to perform compression about 6 times or less. More preferably, compression may be performed about 3 times or less.

At substantially the same time as each set of data is compressed, it may be desirable to create one or more files that include information on how to reconstruct the original data to its decompressed format. In one embodiment, an index file may be created for the set of data at substantially the same time as each set of data is compressed. It may be desirable for the index file to include information on how to decompress the file including, but not limited to, the algorithm that was used to compress the data. In embodiments where iterative compression may be performed, a substantially separate index file may be created for each compression. It may be desirable for each index file to indicate which compression it is associated with, such that a processor may be capable of reconstructing the original decompressed file based on each of the plurality of index files. In one embodiment, this may be accomplished by attaching the index files to the compressed files in a particular order. In other embodiments, this may be accomplished by including identifying information in the plurality of index files that indicates the order in which the processor should reference the files to reconstruct the original, uncompressed data. It may be desirable to store the one or more index files and the compressed data to a memory such that it is accessible to the processor.

As mentioned above, the present invention may be capable of compressing more than one set of data. The sets of data may be compressed at substantially different times or they may occur substantially simultaneously. In one embodiment, it may be desirable to compress a second set of data after a first set of data has been completely compressed. In such an embodiment, each set of data may be compressed based on the algorithm that produces the best compression ratio, as described in detail above. After the compression of the second set of data is completed, the second set of compressed data may be stored in the memory with the first set of compressed data. In some embodiments, it may be desirable to compress several sets of data together. For instance, it may be preferable to store a plurality of sets of associated data together. In such an embodiment, the user interface, as described below, may be capable of providing an indicator that shows the boundaries between each of the plurality of sets of data. The indicator may include, but is not limited to, a flag, header, footer, and the like. In this embodiment, the indicator may allow the user interface to decompress one of the plurality of sets of data without decompressing the other sets of data. One advantage of this method of decompression may be that a desired set of data may be decompressed while minimizing the time and expense necessary for the data to be decompressed. Additionally, storage space in memory is typically limited. Decompressing each of the plurality of sets of data when it is only desirable to access a single set of data may be unfeasible due to space limitations. In other words, the available memory storage space may be sufficient to decompress one of the plurality of sets of data, but insufficient to decompress each of the plurality of sets of compressed data.

In many applications, encryption may be important to protect confidential information. This may be especially true for applications that involve transmitting sensitive information over a wide area network (WAN), such as the Internet. In addition, it may be desirable to encrypt information that may be stored to memory, such as a disk or the like, to prevent it from being decoded by an unauthorized user. As described above, in one embodiment one or more of the plurality of algorithms may compress data by removing and indexing repeating bit patterns. In this embodiment, the data may be encrypted as a by product of the compression. In other words, by removing and indexing repeating bit patterns, the compressed data is unintelligible until it is decompressed and/or reconstructed. One advantage of the encryption may be that the data may not be decompressed without knowledge of the algorithms and the order in which they should be used to decompress the file. Another advantage of compressed data is the encryption that results because the data does not have a predictable file format. This may be desirable because viruses and other harmful or malicious codes or data strings typically attach themselves to data that is formatted in a particular manner. Removing and indexing repeating bit patterns substantially minimizes the ability of malicious viruses or codes being able to attach to the compressed data. In other embodiments, the compressed data may be encrypted using other methods, such as separate software programs.

As described above, data may be compressed using one or more algorithms. In these embodiments, an index file including the algorithm used for compression may be linked to the compressed data. When it is desirable to access the original data, the index files may be referenced in order to reconstruct the data to its original format. In one embodiment, compressed data may be decompressed and reconstructed one file at a time or collectively using data in the index as new files are added, resulting in the compression being optimized to include the new data, which is reflected in the index.

Archiving and Recall

Many companies typically store information in a central database such as SQL, DB2, Oracle, and the like. The central database may be operatively connected to other elements, such as additional remote databases, servers, and the like, based on a data network. Often, data that has high importance, or is accessed often, is stored in the central database. However, other data that has lower importance or may not be accessed often may be stored in the remote databases that are operatively connected to the data network.

The data stored in the remote databases oftentimes comprises important information that may be useful in a variety of situations. However, much of the unstructured data stored is very difficult to retrieve. Typically, requests for access to this information involve an arduous process of recovery on an “ad hoc” basis. According to one aspect of the present invention, data may be archived and searched in an efficient manner. In one embodiment, archived data is compressed as described above. In addition, if a user desires access to archived information, the present invention may be capable of determining the location of the archived data and retrieving it from any of a plurality of locations on the data network.

In one embodiment, data may be archived in any desirable manner known to those skilled in the art. For example, it may be desirable to archive data based on a set of “rules” that control which data files are archived. Preferably, the rules are set by a user based on, for example, a user interface, as described below. The rules may be based on, for example, the types of data to be archived, the frequency with which those files should be archived, file size, time of last access, last update, file type, and the like. For instance, in one embodiment it may be desirable to archive all MS-WORD documents, based on a file extension of “.doc,” on a periodic basis. One advantage of archiving data based on rules is that the necessity for manual intervention is substantially limited. Thus, files may be automatically archived, freeing valuable storage space for newer or more frequently accessed data.

In one embodiment, the present invention is capable of accommodating any desired number of rules. Preferably, between about 1 and about 500 rules may be set. More preferably, between about 10 and about 200 rules may be set. Most preferably, between about 15 and about 50 rules may be set. In another embodiment, about 10 or more rules are preferably set. More preferably, about 50 or more rules may be set. Most preferably, about 200 or more rules may be set.

According to one aspect of the present invention, after the rules are established, the time of execution of the rules may be set as desired. Archiving large amounts of data typically consumes valuable data network resources. In one embodiment, the archiving of files may be executed at predetermined time intervals, such as daily, weekly, monthly, yearly, and the like. In another embodiment, specific times of execution may be established to coordinate with network demand. For example, one or more rules may be scheduled to execute at off-peak times in order to optimize the use of data network resources. In such an embodiment, the execution of the archiving preferably occurs during one time period.

In another embodiment, however, the execution of the archiving rule does not have to be completed during one time period. In other words, the present invention may be capable of executing a rule during two or more time periods. This may be useful, for example, to accommodate instances where high network usage occurs during a time period that normally has low network usage. When such a situation occurs, it may be desirable to delay or interrupt the execution of a rule. Thus, in one embodiment, the present invention is capable of determining the level of network usage and executing a rule when the network usage level is below a predetermined threshold.

In one embodiment, the determination of the level of network usage and the execution of the rule may be controlled by, for example, a processor, computing device, computer, and the like. In such an embodiment, a rule may be partially executed. That is, a portion of data may be archived during a first time period. If, for example, network usage increases above a predetermined threshold during the archiving process, the archiving may be interrupted. When the processor determines that network usage has decreased below the predetermined threshold, a second portion of data may be archived during a second time period. This preferably allows data archiving to be executed without burdening data network resources. Preferably, execution of the archiving process may interrupted any desired number of times. The execution may be restarted at a predetermined time, or alternately, when the network usage decreases below a predetermined threshold.

In addition to being able to monitor the level of network usage, the present invention may also be capable of monitoring and changing the rate of a processor in any network element, such as a server, database, memory, and the like. In one embodiment, the present invention is capable of controlling the amount of processing time that is used by the execution of the archiving process. Additionally, the present invention may be capable of controlling the amount of processing time that is used by the compression and decompression processes.

In one embodiment, controlling the rate of processor usage may be accomplished by controlling how many processor time cycles are used for archiving. This may be done by, for example, varying the scan rate of data. In other words, the frequency with which data is scanned to determine if it needs to be archived may be increased, decreased, or maintained, as desired.

As mentioned above, the retrieval of archived files is typically a time consuming, arduous process that is performed on an ad hoc basis. In one embodiment, the rules used for archiving data may be useful to, for example, manage storage, retrieval, and restoration of archived files over the data network. Preferably, the rules are capable of allowing a user to retrieve data from any point on a data network, such as a server, database, memory, and the like.

In one embodiment, the present invention is capable of generating a keyword index. Preferably, a group of data may be archived as one or more files. Accordingly, the keyword index comprises a list of a plurality of keywords found in the archived files. The archived files may include, but are not limited to, documents, email, MS-Office Suite output files, graphics, audio, video, and the like.

In one embodiment, each archived file may be stored at any point on the data network. In other words, a file stored in the central database may be archived to a remote database, or any other memory that is operatively connected to the data network. According to one aspect of the present invention, the keyword index is preferably generated at substantially the same time as the data files are archived and compressed. In one embodiment, as each file is compressed, it is preferably scanned to determine if any keywords are present. This may be done in any desired manner. For example, the keywords may be predetermined. That is, a processor may be instructed to search each archived file for desired keywords. Alternately, a file may be searched, and each of the words included in the file may be indexed. This process may be repeated for each of a plurality of archived files. In embodiments where a file comprises graphics, audio, or video data, one or more keywords may be entered by a user at the time the file is saved. Alternately, the keyword search may be based on, for example, the name or description of the file.

In one embodiment, it may be desirable for the keyword index to be stored in the central database. Preferably, the keyword index includes a “pointer” for each word in the index. It is desirable for the pointer to allow a processor to determine the actual location, such as a remote database, server, and the like, of an archived file. Despite the fact that the archived files may not be stored in the central database, it is still possible to search the files based on the keyword index that is stored there. As such, the present invention is capable of providing substantially immediate access to a “Virtual Information Database” of archived files. If a user desires a particular archived file, a processor included in the central database may be able to use the pointer from the keyword index to determine its location in order to retrieve and decompress it.

In one embodiment, once an archived file's location is determined based on the pointer, the file may be transmitted to the central database and stored, based on the data network (if the file does not already reside in the central database). Once the file is stored in the central database, it may be decompressed, as described above. However, in other embodiments the archived file may be decompressed in a remote database and then transmitted and stored in the central database. Those skilled in the art will recognize that an archived file may be retrieved and transmitted in any number of ways. For example, in other embodiments an archived file may be located based on a pointer and then transmitted over a data network to a personal computing device. The file may then be decompressed by, for example, the personal computing device. Personal computing devices may include, but are not limited to, laptop computers, desktop computers, Personal Digital Assistants (PDA's), cellular telephones, and the like.

Reporting

In some applications it may be desirable for a user to be capable of determining statistics related to the use of a process, memory, other network resources, and the like. In one embodiment, the present invention may be capable of performing such a process by generating a record, or log, of performance statistics such as computer usage, disk storage space used, number of files archived, type of files archived, size of files archived, amount of storage space saved in compressed archive format, and the like. When desired, the present invention may be capable of accessing this information and presenting it in a format that is understandable to a user, such as a report. One advantage of such a report is that it may be used to allocate capacity for network and storage resources. In many applications, this may result in considerable cost and time savings.

The Interface

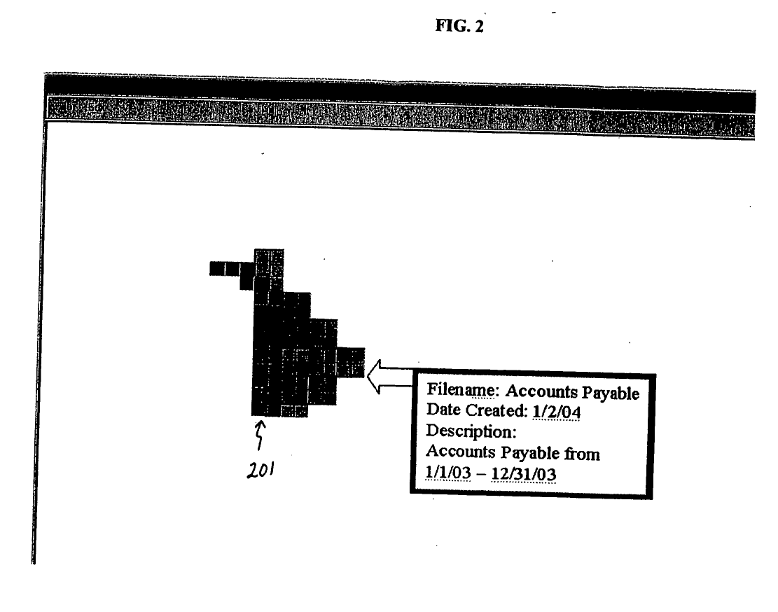

In one embodiment, the present invention may be capable of performing data compression based on a user interface. The user interface may include, but is not limited to, a graphical user interface. FIG. 2 is a diagram showing an exemplary graphical user interface. Preferably, the graphical user interface may be displayed using a computer or computing device. The user interface may allow a user to compress data on a single computer. Alternately, the user interface may allow an administrator, such as a network administrator, to reduce the space consumed by data storage within a server, database, or other networked computing device.

In one embodiment, the user interface may be used to perform a variety of functions. This may include, for example, initiate data compression, managing files, and the like. As is well known to those skilled in the art, files include data and are typically accessible using a computer, computing device, processor, and the like. Each file may comprise one or more sets of data. In this embodiment, a user may select the one or more files to compress by choosing the files from, for example, a directory. The desired files may be selected and “dragged,” or otherwise moved, to a set of compression file folders. The compression file folders allow the files to be separated according to, for example, their importance. The files may be separated according to user-defined specifications. Accordingly, the file folders may be customizable to separate files according to any desired criteria. In one embodiment, there are three compression file folders corresponding to, high, medium, and low importance levels. The desired files may be selected and moved to one of the compression file folders based on the importance level assigned to them by a user. However, in other embodiments, the file folders may have different labels and divide the files into categories based on other desired criteria. In another embodiment, one or more directories comprising a plurality of files may be moved into one of the compression file folders. In this embodiment, each of the files may be compressed and stored in the memory. A compression ratio is determined for each file in the directory, which allows each file to be compressed separately. This also provides the advantage of allowing each file in the directory to be decompressed individually, as described in more detail below.

In one embodiment, after moving the desired files to the compression file folders, the files are compressed as described above. Each file may correspond to one or more sets of data, as described above. Accordingly, each file may be compressed based on one or more algorithms that produce the best compression ratio for each file. This process may be repeated for each of the files that are placed into the compression file folders. In this embodiment, the compression of the files is transparent to the user. In other words, it may only be necessary for the user to move the file or files to one of the compression file folders in order to compress the files. From a user's perspective, the files appear to be automatically compressed and stored subsequent to being moved into the compression file folders.

In this embodiment, at substantially the same time that each file is compressed, an associated index file may be created. The index file preferably comprises information that may be used to reconstruct the original file. The index file may include, but is not limited to, the one or more algorithms used to compress the original file. It may be preferable to link the index file and the compressed file. This may be accomplished using any desired method, such as adding the index file to a desired portion, for example, the beginning or end, of the compressed file. Linking the one or more index files to the compressed file may facilitate decompression and reconstruction of the file.

In one embodiment, a user may create a descriptive tag for each compressed file. This may be desirable in embodiments where a large number of files may be compressed. The descriptive tag may include any text desired by the user, such as a description of the compressed files contents. In other embodiments, the descriptive tag may include audio, video, or the like. It may be desirable for the descriptive tag to be compressed according to the method described above. Preferably, the descriptive tag may be linked to the compressed file and the index file. The descriptive tag may be linked to the file in any desirable manner, for example, by attaching it to the beginning or end of the compressed file or index file. Additionally, a password may be associated with each compressed file to control file access. This may be particularly preferable in applications involving the transmission of files from one user to another.

As mentioned above, the user interface may include a graphical user interface, or graphical display, shown in FIG. 2. In one embodiment, the graphical interface displays a representation of the files based on the importance level assigned to them by the user. The graphical user interface preferably represents the compressed files by associating colored squares 201 with the compressed files. It may be desirable to match the color of the squares with their associated level of importance, as assigned by the compression file folders. In one embodiment, red squares are associated with files of high importance, yellow square are associated with files of medium importance, and green squares are associated with files of low importance. One advantage of the color coded graphical representation of the files is that a desired file may be more easily located based on its assigned importance. Another advantage of the color coded graphical representation is that the files may be archived after a desired date based on their importance.

The user interface may also be used to search the compressed files by, for example, a category, keyword, and the like. In one embodiment, keywords of interest may be entered into a search page accessible using the user interface. A computer processor may then be used to perform the search, whose results may be displayed based on the user interface. In such an embodiment, the results of the search may be displayed using the graphical display. The files that include the searched keywords may be displayed according to their importance using the representations of red, yellow, and green squares described above. A pointing device, such as a computer mouse, may be used to scroll over a desired square. As the mouse cursor is placed over a red, yellow, or green square, the compressed filename and descriptive tag may be displayed. Allowing a user to view the name of the file and the descriptive tag of the file provides the advantage of allowing a user to open only a selected file or files without burdening the computers resources.

In another embodiment, the user interface may be used to search the compressed files based on, for example, the keyword index that is described above. In such an embodiment, a user may access the keyword index using the user interface. It may be desirable for the keyword index to be organized alphabetically in order to allow a user to easily find a desired keyword. Once a user finds a desired keyword, they may select it by moving a cursor over the keyword. In one embodiment, after the keyword is selected a drop down menu showing substantially all of the files that include the chosen keyword may be displayed.

In one embodiment, the keyword index may include a searching function. Preferably, the searching function allows a user to search within a specific keyword based on, for example, file size, time of last access, last update, file type, and the like. The user may then have the option of selecting one or more desired files. In one embodiment, it may be desirable to allow a user to designate a point on the network at which the one or more files should be decompressed and viewed. After selecting the one or more files, the file may be retrieved, decompressed, and viewed.

In some applications, it may be desirable to perform one or more operations on the compressed file. Typical operations may include, but are not limited to, modifying a compressed file, emailing the compressed file, deleting the compressed file, verifying that the decompressed file matches the original source file, restoring the decompressed file to its original source location, and the like. These operations may be performed using the graphical user interface. As described above, a single set of data may be decompressed without decompressing each of the plurality of sets of data. Accordingly, a single file may be decompressed without decompressing other files. Thus, in one embodiment a compressed file may be modified by decompressing the file to a temporary folder and launching it using an appropriate software application. In this embodiment, the decompressed file in the temporary folder may be modified and then saved. Once the software application is terminated, the modified file may be moved back into the appropriate compression file folder and recompressed.

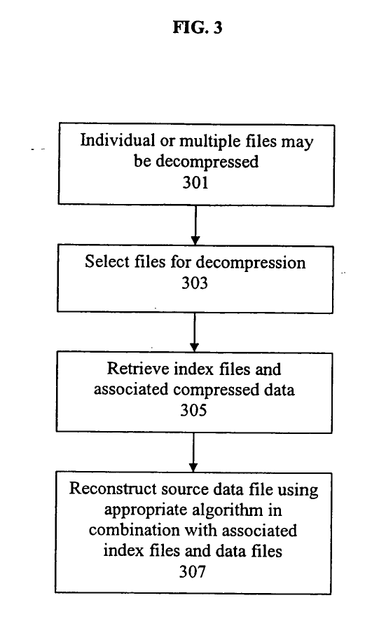

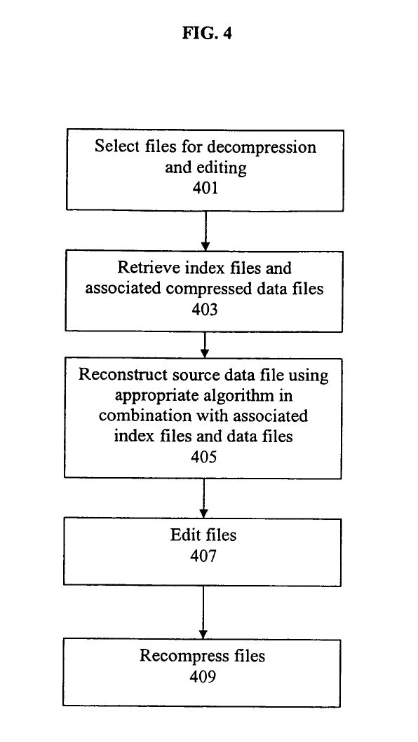

FIG. 3 is a flow chart showing exemplary steps in the decompression process. In one embodiment, individual or multiple files may be decompressed (Step 301). Preferably, one or more files are then selected for decompression (Step 303). As illustrated by step 305, the processor may decompress the files by, for example, retrieving the index files and associated compressed data files. The original, uncompressed source data file may then be reconstructed using, for example, one or more appropriate algorithms in combination with associated index files and data files (Step 307). As illustrated by FIG. 4, the files may also be decompressed and edited. In one embodiment, the files may be selected for decompression and editing (Step 401). The index files and associated compressed data files may then be retrieved (Step 403). The appropriate algorithms, in combination with associated index files and data files may then be used to reconstruct the original source files (Step 405). The files may then be edited (Step 407), and then recompressed (Step 409), as described above.

In another embodiment, the user interface may be used to add additional compressed files to the files that have already been compressed. In this embodiment, a decompressed file may be moved from a directory within the computer memory to one of the compression file folders. Upon being moved into one of the compression file folders, the file may be compressed and stored in the computer memory. Other functions may be performed using the user interface. For example, a selected compressed file may be emailed to another user. In this embodiment, the compressed file may be emailed by using an email option included in the user interface. Preferably, the file is transmitted in its compressed form. This provides the advantage of reducing the time and resources necessary to transmit the file to the email recipient. In another embodiment, the user interface may include a function that allows verification that a decompressed file matches the original source file. In other embodiments, the user interface may include a function that allows a decompressed file to be restored to its original source location. While the present invention has been described with respect to select computer operations, it will be understood by those skilled in the art that the present invention may be used in conjunction with any of a plurality of computer functions known to those skilled in the art, such as email, deletion, modification, restoration, display, transmission, and the like.

In some embodiments, the present invention may be capable of automatically managing files. For example, in one embodiment it may be preferable to automatically compress files that are stored on a computer memory. This may be accomplished using, for example, the user interface. In this embodiment, a user may pre-select files to be compressed according to factors including, but not limited to, a specific time, file size, file age, file type, and the like. In this embodiment, files that meet the desired criteria would be automatically placed into selected compression file folders and compressed automatically, without further user intervention. In other embodiments, the user interface may be used to prompt a user to change the importance level of a compressed file based on a desired factor, such as the frequency with which a file is accessed. Because computer memory space is limited, providing a prompt to change the importance level of a compressed file may provide the advantage of allowing faster archival of compressed files to another type of memory, such as a disk, CD-ROM, optical disk, or the like.

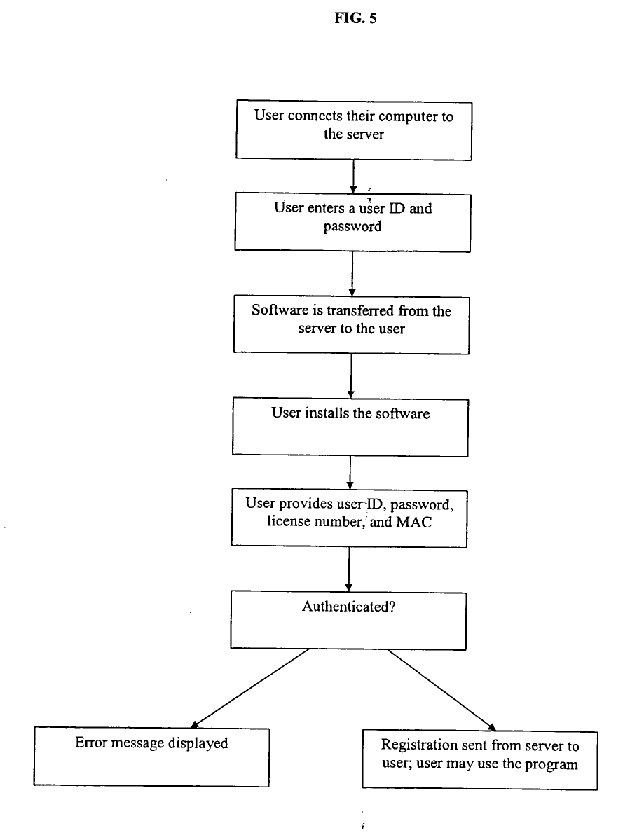

In one embodiment, the present invention may comprise a computer program product or software program. In such an embodiment, the software program may be transmitted to a user or network administrator over a WAN, such as the Internet. In this embodiment, shown in FIG. 5, a user connects their computer to a remote server by accessing a website on the Internet. The user preferably enters a user identification (ID) and password. The user ID and password may be acquired through the website, email, telephone, or any other convenient method. The appropriate software may then be transmitted from the remote server to the user's computer.

The user may then install the software onto their computer using, for example, an installation wizard. In order to prevent unauthorized users from using the software, the user preferably provides their user ID, password, license number, and Machine Address Code (MAC). The user's computer then communicates with the remote server via, for example, the Internet. If the user's information is authenticated, the user is able to request a registration key from the remote server. This information may be sent via any desired method, such as email, postal mail, telephone, and the like. After the registration key is provided to the software application, the software may be used to perform a variety of functions including, but not limited to, compressing files, decompressing files, managing files, outputting files, or accessing help files. If the user's information is not authenticated, an error massage may be displayed to the user indicating the information that was invalid and prompts the user to correct the invalid information.

Digital Identification Mark

In a preferred embodiment, the user interface may be used in applications involving electronic authentication. In this embodiment, the user interface may be capable of transferring a digital identification mark comprising a compressed data file over a data transmission medium. The data transmission medium may be a network such as a WAN, Local Area Network (LAN), or the like. In an embodiment involving authentication, files are compressed based on a compression ratio, as described in detail above. A digital identification mark including a unique authentication code may also be generated. Preferably, the digital identification mark is also compressed based on the algorithm that produces the best compression ratio, as described above. The compressed digital identification mark and the compressed files may then be combined and compressed according to the method described above. The combined files and digital identification mark may then be transmitted in a compressed form over a data transmission medium.

In one embodiment, the digital identification mark comprises a unique digital mark that may be attached to all communications, such as email, VoIP, and Instant Messaging. The digital identification mark may comprise a unique graphic image, picture; any desired textual information, and the like. In one embodiment, the digital identification mark may be used to authenticate any electronic transaction. For example, it may be desirable to authenticate a document or file that is to be transmitted. In this embodiment, a user selects one or more files to be electronically authenticated using the user interface. The authentication function may be part of the compression software described above, or it may be transmitted to a user from a server in a substantially similar manner. The file may be selected using any desired method, such as moving the file into an authentication folder, or selecting a file and then using a mouse cursor to select an authentication function included in the user interface. After selecting one or more files to be electronically authenticated, a user's digital identification mark may be sent to a remote server. The server may be the same as the server described above with respect to the compression software, or it may be a separate element. If the digital identification mark server is a separate element, it may be desirable for the compression software server and the digital identification server to be capable of communicating with each other.

Upon receiving the digital identification mark, specific information related to that request, such as time, owner profile, recipient, and the like, are recorded by the server. The server then modifies the users digital identification mark by adding unique information related to the particular transaction, such as the time of the transaction, owner profile, recipient, and the like. The information that is added preferably makes the digital identification mark unique for a given transaction. One advantage of changing the digital identification mark for every transaction is that the digital identification mark may only be used for a single transaction. In other words, the digital identification mark used for one transaction may not be used to authenticate another transaction. In one embodiment, each time a user uses the digital identification mark a copy of the event may be recorded and stored in a database that is operatively connected to the server. In some embodiments, it may be desirable to transmit an authenticated file to several users sequentially. In such an embodiment, each time a new digital identification mark is generated and stored in the database, it may be linked to previous digital identification marks. One advantage of this method is that the digital identification marks may be used to determine a “chain of custody” of identification mark ownership. In other words, the authenticity of the file may be verified as it is passed between users. In another embodiment, the authenticity may be verified by attaching each new digital identification mark to the digital identification mark that was previously attached. A user would then be able to see the digital signatures of each user who verified the document.

In other embodiments, the digital identification mark may be used to prevent identity theft. For example, if a document, such as a credit application is authenticated with a false digital identification mark, the digital identification mark may be submitted to the database for verification. The database and server may be capable of determining whether or not it was associated with the correct user. This may be a valuable tool for merchants, financial institutions and consumers, reducing risk and improving e-commerce business practices. The digital identification mark may also be used in transactions where an electronic identity needs to be verified, such as electronic signing of credit card transaction, signing legal documents, signing email, and the like. In the case of a credit card transaction, a copy of the signature may be recorded. In one embodiment, a user may access the database to verify whether or not a transaction and signature is valid.

In another embodiment, the digital identification mark may be used to authorize online purchases. While a user is at an ecommerce website, such as Amazon.com, they may request their digital identification mark from the server. In one embodiment, the digital identification mark application may be launched from, for example, the Menu Bar of the Internet Explorer. The Menu Bar may display an icon that allows a user to authorize a particular transaction. By selecting the icon, a unique digital identification mark may be generated by the server and attached to the current URL webpage address and transaction contents. This provides the advantage of allowing the online merchant to verify that the user has verified the transaction by attaching their digital identification mark. Preferably, a copy of this transaction may also be stored in the database to prevent a user from reneging on the transaction.

Although the present invention has been described with reference to particular embodiments, it will be understood to those skilled in the art that the invention is capable of a variety of alternative embodiments within the spirit of the appended claims.

1. A method for determining the location of one or more archived files, comprising:
generating a keyword index based on one or more keywords included in a file;
storing the keyword index at a first point on a data network;
storing the file at a second point on the data network, wherein the stored file is capable of being stored in a compressed format; and
determining the location of the stored file based on the keyword index.

2. The method according to claim 1, further comprising:
searching the keyword index;
selecting at least one keyword, wherein the keyword includes a pointer that stores the location of the file on the data network; and
transferring the file from the second point to the first point based on the at least one selected keyword.

3. The method according to claim 2, further comprising decompressing the file.

4. The method according to claim 1, wherein the file comprises one of a document, email, MS-Office Suite output file, graphics, audio, and video.

5. The method according to claim 1, wherein storing the file in a compressed format comprises:
analyzing the file based on a plurality of algorithms to determine a compression ratio for each algorithm; and
compressing the file based on the algorithm that produces the best compression ratio.

6. The method according to claim 1, wherein the determining comprises transferring the file from the second point to one of the first point and a third point based on at least one selected keyword.

7. The method according to claim 1, wherein the keywords comprise one of:
predetermined keywords; and
at least some of a plurality of words included in the file.

8. The method according to claim 1, wherein the storing the file at the second point on the data network is based on one or more rules.

9. The method according to claim 8, wherein the one or more rules comprises at least one of file size, time of last access, last update, and file type.

10. The method according to claim 8, wherein the rules are executed when network usage is below a predetermined threshold.

11. The method according to claim 1, wherein the storing the file at the second point occurs during more than one time period.

12. The method according to claim 1, further comprising:
monitoring the rate of processor usage based on the storing the file at the second point on the data network; and
controlling the amount of processing time used based on the monitoring.

13. The method according to claim 1, wherein the keyword index is capable of being viewed based on a user interface.

14. The method according to claim 1, wherein the one or more keywords are capable of determining the location of the second point.

15. The method according to claim 1, wherein the compressed file is capable of being searched based on the keyword index.

16. A method of searching a plurality of stored files, comprising:
generating a plurality of keywords based on a plurality of files;
generating a keyword index based on the plurality of keywords;
storing the plurality of files based on a compressed format;
searching for at least one compressed file based on the keyword index; and
retrieving the at least one compressed file based on the keyword index, wherein the plurality of keywords are capable of determining the location of the at least one compressed file.

17. The method according to claim 16, wherein the plurality of files are stored at a first location on a data network and the keyword index is stored at a second location on the data network.

18. The method according to claim 16, wherein the plurality of keywords include a plurality of pointers that are capable of storing the location of the plurality of files.

19. The method according to claim 16, wherein the plurality of files based on the compressed format are capable of being searched based on the keyword index.

20. The method according to claim 16, the compressed format comprises:
analyzing each of the plurality of files based on a plurality of algorithms to determine a compression ratio for each algorithm;
compressing each of the plurality of files a first time based on the algorithm that produces the best compression ratio;
analyzing each of the plurality of compressed files based on the plurality of algorithms to determine a compression ratio for each algorithm; and
compressing each of the plurality of files iteratively based on the algorithm that produces the best compression ratio.

21. The method according to claim 16, further comprising decompressing the at least one file.

22. The method according to claim 16, wherein the file comprises one of a document, email, MS-Office Suite output file, graphics, audio, and video.

23. The method according to claim 16, wherein the plurality of keywords comprise one of:
predetermined keywords; and
at least some of a plurality of words included in the plurality of files.

24. The method according to claim 16, wherein the plurality of files are stored at the first location based on one or more rules.

25. The method according to claim 24, wherein the one or more rules comprises at least one of file size, time of last access, last update, and file type.

26. The method according to claim 24, wherein the rules are executed when network usage is below a predetermined threshold.

27. The method according to claim 16, wherein the storing the plurality of files occurs during more than one time period.

28. The method according to claim 16, further comprising:
monitoring the rate of processor usage based on the storing the plurality of files; and
controlling the amount of processing time used based on the monitoring.

29. The method according to claim 16, wherein the keyword index is capable of being viewed based on a user interface.

30. A method of searching a plurality of stored files, comprising:
generating a keyword index based on a plurality of files;
storing the plurality of files based on a compressed format;
searching for at least one compressed file based on the keyword index;
retrieving the at least one compressed file based on the keyword index; and
decompressing the at least one file.

31. The method according to claim 30, wherein the keyword index and the plurality of compressed files are stored at substantially separate locations.

32. The method according to claim 30, wherein the keyword index comprises a plurality of pointers capable of storing information about the location of each of the plurality of files.

33. The method according to claim 30, wherein the keyword index is stored in a central database.

34. The method according to claim 30, wherein the plurality of files are stored in a remote database.

35. The method according to claim 30, wherein the compressed format comprises:
analyzing each of the plurality of files based on a plurality of algorithms to determine a compression ratio for each algorithm;
compressing each of the plurality of files a first time based on the algorithm that produces the best compression ratio;
analyzing each of the plurality of compressed files based on the plurality of algorithms to determine a compression ratio for each algorithm; and
compressing each of the plurality of files iteratively based on the algorithm that produces the best compression ratio.

36. The method according to claim 30, wherein the file may be decompressed based on at least one of a laptop computer, a desktop computer, a Personal Digital Assistant (PDA), a cellular telephone, a database, and a server.

37. The method according to claim 30, wherein the decompressing comprises decompressing the plurality of compressed files based on an index file that is attached to the file.

38. The method according to claim 30, wherein the plurality of files are stored based on one or more rules.

39. The method according to claim 38, wherein the one or more rules comprises at least one of file size, time of last access, last update, and file type.

40. The method according to claim 38, wherein the rules are executed when network usage is below a predetermined threshold.

41. The method according to claim 38, wherein the storing the plurality of files occurs during more than one time period.
